(19) United States
(12) Patent Application Publication
(10) Pub. No.: US 2007/0016518 A1
(43) Pub. Date: Jan. 18, 2007

(54) SYSTEM AND PROCESS FOR PROVIDING LOANS OR OTHER FINANCING INSTRUMENTS

(76) Inventors: Paul Atkinson, Poway, CA (US); Ronald S. Conero, San Diego, CA (US); Charles A. White, Oakland, CA (US)

Correspondence Address: WILLIAM J. KOLEGRAFF, 3119 TURNBERRY WAY, JAMUL, CA, 91935, US

(21) Appl. No.: 11/457,034

(22) Filed: Jul. 12, 2006

Related U.S. Application Data
(60) Provisional application No. 60/698,805, filed on Jul. 12, 2005.

(51) Int. Cl. G06Q 40/00

(52) U.S. Cl. 705/38

(57) ABSTRACT

Automated financing products, services, and processes are enabled by the more complete, timely, and accurate information provided by a conditional access network. In one example, the financing product is an automated loan process. The automated loan process is able to receive timely product information, such as product status and location, and adapt loan terms, rate, or loan amount responsive to the information. For example, a loan may be adapted according to product activations, products that are deactivated, or according to which distributor is holding product. Information from the conditional access network may also be used to evaluate repayment terms. For example, the loan provider can use information from the conditional access network to confirm status of collateral, and accelerate the loan as appropriate. In this way, loan risk is reduced.

### RELATED APPLICATIONS

This application claims priority to U.S. patent application No. 60/698,805, filed Jul. 12, 2005, and entitled “Conditional Access Network for Providing Loans, which is incorporated herein in its entirety.

### BACKGROUND

1. Field

The present invention relates computer processes for providing loans. More particularly, the invention relates to automated processes that adaptively provide information for delivering loan products.

2. Description of Related Art

Providing loans or other financing instruments, are by their nature, a risky business. Financial instruments, such as loans, credit instruments, debt instruments, or other debt obligations are often used to finance and support business activities. To simplify discussion, this application will particularly address loans, but it will be understood that other financing instruments may be used. In the financial and loan business, better information, and more timely information, leads to better loan products. Loans are regularly advanced to companies based on the aggregate amount of accounts receivable or inventory that they have outstanding. Such loans are priced and these obligations undertaken based upon the risk of collection that is perceived to exist. A component of this risk is the possibility of loss and theft of the products underlying the obligations. These products are used as collateral for the loan, which the creditor will liquidate in the case of a loan default. Accordingly, the creditor needs to understand the value of the products in the distribution chain, and the risk that the products will not be sold. Some loans use accounts receivable as security for a loan. However, in many businesses, decisions to book accounts receivables are based upon a variety of rules that can result in greater or less risk being assigned in this type of loan instrument.

The pricing of loans can also be influenced by the distribution channels associated with a particular products. There can be significant differences in the performance of different distribution channels with respect to product returns, for example. Products that are distributed to wholesale and retail clients can be subject to high levels of returns by these entities when they are ultimately not sold. While these variations relate directly to the risk of the loan, they are frequently not clear to a potential lender.

### SUMMARY

Briefly, the present invention provides new automated financing products, services, and processes, which are enabled by the more complete, timely, and accurate information provided by a conditional access network. In one example, the financing product is an automated loan process. The automated loan process is able to receive timely product information, such as product status and location, and adapt loan terms, rate, or loan amount responsive to the information. For example, a loan may be adapted according to product activations, products that are deactivated, or according to which distributor is holding product. Information from the conditional access network may also be used to evaluate repayment terms. For example, the loan provider can use information from the conditional access network to confirm status of collateral, and accelerate the loan as appropriate. In this way, loan risk is reduced.

The automated loan system relates to creating or providing loan products and services for individuals or legal entities which have an ownership or other beneficial interest in targets that are part of a conditional access network. These products and services make use of the ability of a processor or other device associated with a target to provide authorized parties with conditional access to the target and to deny access to a target by unauthorized parties. Loans or other debt instruments (collectively referred to herein as “loans”) are created in the present methods, for example, by establishing a line of credit for a manufacturer, wholesaler, or other entity with an ownership or other beneficial interest in targets. The line of credit can be modified (increased or decreased) based on authenticated events, or information derived from authenticated events, received from a conditional access network which includes the targets. Other loan instruments which can be established according to the present methods include debit accounts and credit accounts.

Loans established using this system are generally priced by evaluating risk factors associated with targets that participate in a conditional access network, such as the rate of loss associated with an activated target, the creditworthiness of a distributor, or the rate of return transactions. Such factors can be evaluated by examining authenticated events, such as sales or return transactions. Tax payments associated with the targets can likewise be evaluated by examining such authenticated events.

Entities that have an ownership or other beneficial interest in targets are potential clients for the issuer of a loan according to the present methods. A lender can verify that the targets securing the loan are part of a conditional access network or that a potential client participates in such a network by accessing the conditional access network, for example.

### BRIEF DESCRIPTION OF DRAWINGS

These and other features, aspects and advantages of the present invention will become better understood with regard to the following description, appended claims, and accompanying figures where:

FIG. 1 is a flowchart of a system for providing a financing instrument in accordance with the present invention.

FIG. 2 is a block diagram of a network system for providing information to support financing instrument products in accordance with the present invention.

FIG. 3 is a flowchart of a process for providing financing instruments in accordance with the present invention.

FIG. 4 is a flowchart of a process for providing financing instruments in accordance with the present invention.

FIG. 5 is a flowchart of a automatically adapting a financing instrument product in accordance with the present invention.

FIG. 6 is a flowchart of a automatically adapting a financing instrument product in accordance with the present invention.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

The ability to deny access to a feature of a target and to securely enable an authorized and authenticated party access to such feature can broaden the range of possible distribution channels for a product, and thereby increase sales opportunities. In particular, it enables the creation of new types of financing products that are tailored to reflect the enhanced information available about targets that participate in a conditional access network. Such information can be used, for example, by financial service providers to offer enhanced loans against accounts receivable, floor-financing, or factoring services, to conditional access network participants. It will be appreciated that the disclosed systems are application to a wide range of financing instruments and programs. Although descriptions address the loan financing instrument as an example, it will be understood that other financing instruments may be used.

For targets participating in a conditional access network, it is possible to make a loan against accounts receivable or inventory on a much more secure basis, as it is possible to have timely and accurate information reflecting an authenticated transfer to and from the various entities in the supply chain for a given target (e.g. distributor, retailer and end customer). By basing the loan instrument upon targets participating in a conditional access network, there is likely to be a lower rate of loss due to theft of such targets because access to beneficial features of the targets can be denied to the thief. Loan prices can be influenced by detailed information about authenticated events involving such targets, such as activation, return events or changes in title (ownership). The amount of a loan outstanding at a given time can also be modified based upon these events, enabling a more appropriately priced product to be sold and a more appropriate level of risk to be taken.

A loan instrument created according to the present method can be priced to reflect the reduced level of loss attributable to targets that are allow conditional access or activation. In addition, the level of outstanding loan obligation can be dynamically adjusted to reflect the amount of inventory that is outstanding in the supply chain (e.g., remaining to be manufactured, shipped, or sold). When a target is activated and sold, the amount of the loan can be dynamically increased. Conversely, as targets are returned or “killed” (permanently rendered valueless) the amount of outstanding loan can be reduced. Targets in a conditional access network can be activated, deactivated, or killed, and such activities can be verified, as described herein.

A loan can be issued to manufacturers or wholesalers that participate in a conditional access network according to the present methods. A potential client is identified in the present methods, such as by identifying a participant participating in a conditional access network (e.g., by owning targets that are part of such a network). Validation of the potential client's participation can be made through a network connection to the conditional access network. In order to produce a loan instrument, the targets being used as collateral for such loan are verified as being part of a conditional access network, and thereby being manageable through such a network. The targets, or products, have an attached or integral embedded processor (EP) or other integrated circuit. This embedded processor may be scanned and read by authorized parties in the distribution chain, and the information verified and used by the conditional access network. Preferably, the communication from the reader to the embedded processor is an RF communication. With the parties and products confirmed to be on the conditional access network, the appropriate premium and amount of loan can be established for such targets by evaluating factors such as the amount or volume of targets, the level of historical or prospective risk associated with targets participating in a conditional access network, the nature of and risk associated with a distribution channel into which the targets are to be introduced, and the accuracy and timeliness of information about the distribution and sale of targets when they participate in a conditional access network. Importantly, obtaining such information does not depend on the cooperation and diligence of a distributor.

In addition, the outstanding balance of a loan (i.e., the amount of money owed by a debtor) can be dynamically adjusted to reflect the volume of a target that is outstanding in the supply chain. As targets are activated and sold, the amount of the loan can be dynamically increased to reflect the increased value of the receivables on which such loan is based, for example. As return transactions occur, or as targets are permanently disabled, the amount of the outstanding loan (the amount available for use by the borrower) can be decreased.

The present system can also support dynamic application for loans by participants in a conditional access network. In this method, one or more lenders can establish a relationship with a conditional access provider. The potential client, such as a target manufacturer or wholesaler, can access the lenders through the network. The conditional access provider can forward information concerning the potential client to the lender, and the lender can respond through the conditional access provider connection or directly to the potential client.

The terms, conditions and obligations (financial and otherwise) of the loan product can be linked to conditional access targets in various ways. For example, such terms can be based on the state of conditionally accessible targets, such as whether they are activated for use or are “killed” and can never be activated or used. Other terms which can be linked to conditionally accessed targets include the value of such targets (especially over time, e.g. average or peak value), the value of conditionally accessed targets relative to comparable non-conditionally accessed targets, or the borrower's participation in a conditional access system.

As products (or targets) move through the distribution chain, the status of the products change according to authenticated transactions on the conditional access network. For example, the products may be shipped from the manufacturer in a disabled state, may be disabled through the entire distribution chain, and then be activated at a point of sale location. In another example, the products may be shipped from the manufacturer in a disabled state, and may be permanently disabled by a authorized distribution party if the product was defective, for example. As the status of the product changes, the value for the product also changes, which affects the loan obligations that the targets can support In this regard, the aggregate value of the collateral products may be readily determined by assessing the status for the products or targets.

Interest calculations and determinations of the amounts due under a loan can be generated based on information obtained from the conditional access network concerning the targets which are the subject of a loan. In addition, payments from a debtor to a creditor (e.g., the lender or lender's assignee) can be handled directly through the conditional access network, such as through a central office or network operation center, or can alternatively be made on the debtor's behalf by a third party using information obtained from the conditional access network. Such payments are generally made on a periodic basis.

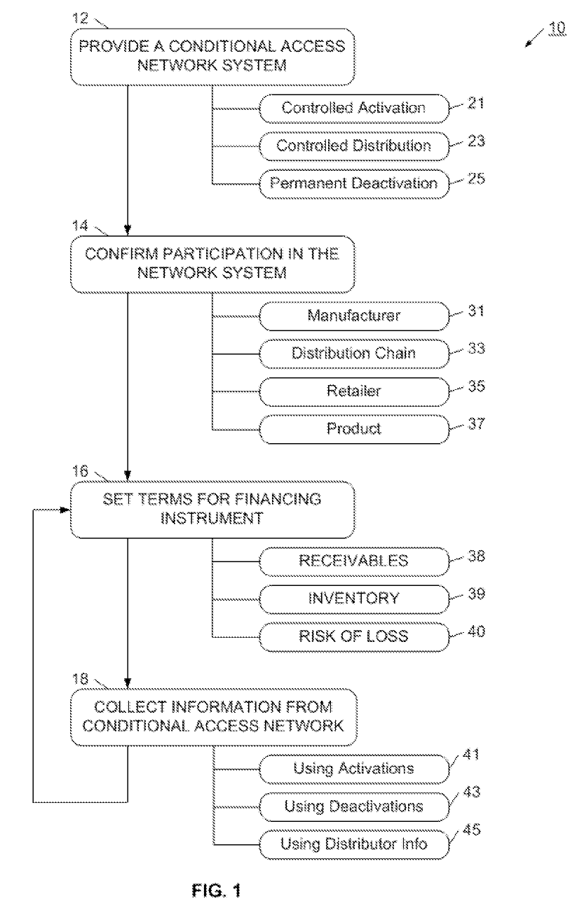

Referring now to FIG. 1, a method 10 for providing loans is illustrated. Method 10 uses information obtained from a conditional access network, which enables a more refined and accurate approach to assess risk and collateral status, and therefore, for pricing and providing loans. Method 10 advantageously enables both the creditor and debtor of loan services to be more informed, and to better manage loan issues, costs, and terms. For example, with more complete and timely information regarding loan terms, debtors can adjust behaviors and processes to obtain better-valued loan products, and to take steps to protect collateral to avoid default conditions. However, prior to fully describing method 10, it may be useful to generally describe the radio frequency integrated circuit, and the conditional access network in which it operates.

Description of the Network System

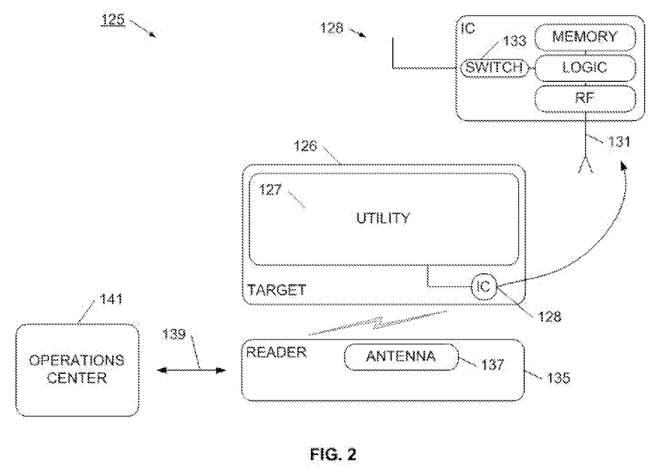

The loan system 10 described with reference to FIG. 1 has been described as operating on a conditional access network system. Referring now to FIG. 2, an example of such a conditional access network system is illustrated. System 125 may operate, for example, in a retail environment, or may be part of a home based activation system. System 125 has target 126, which may be, for example, an optical disc such as a DVD, CD, gaming disc, HD DVD, or Blu-Ray DVD; the target may be an electronic device such as a portable music player, shaver, or drill; or the target may be a passport, driver's license, coupon, or other non-electronic good. It will be understood that target 126 may take other electronic or non-electronic forms. Target 126 has a utility 127, which is typically the primary usefulness for the target device. For example, if target 126 is a portable music player, then utility 127 is the ability to play music files. In another example, if target 126 is a DVD, then its primary utility 127 is to be read by an associated DVD player for presenting a movie or audio file to a user. Typically, utility 127 is the reason consumers are motivated to purchase or otherwise obtain target 126. Stated differently, if utility 127 were unavailable, and target 126 is not an attractive good for the consumer. In a similar way, the target would be unattractive for a thief or shoplifter. Further, by controlling a consumer's access to the utility of a product, a manufacturer is enabled to manage the rights to use the product. In this way, the manufacturer may set the conditions under which a consumer is able to use the physical product, and can even make the product forever unusable, thereby removing it from the stream of commerce. Importantly, this is all managed through a central network operations center, so does not require that the physical goods be returned to the manufacturer to be disabled.

Target 126 has a radio frequency integrated circuit 128. The integrated circuit 128 may be, for example, a tag attached to target 126, or may be integrally formed with other target circuitry or structures. Integrated circuit 128 couples to utility 127, and may selectively activate or deactivate the utility for target 126. For example, a DVD may initially be set such that it is unplayable in most DVD players, but upon an authorized sale, may have its utility activated. In this way, the DVD is unattractive to a thief or shoplifter while the DVD is in the distribution chain, but may be advantageously used by an authorized consumer. In another example, an electronic device has its power circuit disabled at the time of manufacture. The electronic device may then be moved through the distribution chain with a substantially reduced threat of theft. Since the electronic device would be unusable by any potential thief or shoplifter, it is far less likely that anyone will steal or otherwise misappropriate the device. However, at the point-of-sale and upon consummation of an authorized transaction, the power circuit for the electronic device may be activated. In this way, the authorized consumer may normally use the electronic device for its intended purpose.

An enlarged view of integrated circuit 128 shows that integrated circuit 128 has a memory, logic, and a radio frequency portion coupled to antenna 131. Upon receiving appropriate codes or commands via antenna 131, the integrated circuit may cause switch 133 to change states. More particularly, the RF section may receive codes or commands that the logic compares to commands or codes stored in memory. If the received codes match codes secretly stored in memory, then the integrated circuit may determine that an authorized code has been received. This command may, for example, cause the utility 127 to activate, or may cause the utility 127 to deactivate. In one state, switch 133 causes the utility 127 to be unavailable, and in another state causes the utility 127 to be fully available. It will be appreciated that switch 133 may be constructed with more than two states. However, for ease of explanation, switch 133 will be described as having only a deactivated state and an activated state.

It will be understood that switch 133 may take several forms. For example, switch 133 may be an electrochromic material that changes optical characteristics responsive to the application of a voltage. In another example, switch 133 may be fuse, anti-fuse, or other circuit device that is capable of changing electronic states. In yet another example, switch 133 may be a memory logic state, or a circuit device that has a voltage that may be sensed and understood as a logic value. It will also be understood that in some cases switch 133 main be persistently transitioned from a first state to a second state, and in other cases switch 133 may be reversible.

At time of manufacture, IC 128 is typically set to disable utility 127 for target 126. In this way, target 126 is an unattractive theft target, as it is in an unusable or disabled state. At the point-of-sale, which may be a point-of-sale terminal in a retail establishment, a kiosk, or a home activation site, target 126 is placed proximate a reader 135. Reader 135 has an RF antenna 137 and RF transceiver for communicating with IC 128. When positioned proximate reader 135, IC 128 passes identifying information to reader 135, which then communicates the identifying information through a network connection 139 to an operations center 141. The operations center 141 generates or retrieves an activation or authorization code specific for target 126. The activation or authorization code is transmitted back to reader 135 and then communicated to target 126. Provided a proper code is received, the logic causes switch 133 to change state, and activate the utility 127 for target 126. In this way, the target has no or reduced utility through the distribution chain, but is efficiently activated at a point-of-sale.

Although the above description describes an activation process, in a more general case, the IC may be used to selectively make a range of functions available or unavailable, and may make some of these functions only temporarily available. In this sense, the IC and network processes are used to affect the utility of the target. The target with controllable utility may be an electronic device, or alternatively, may be a tangible media, such as an optical disc. The controlled target has a change effecting device that is set to a first state, which allows the target to operate according to a first utility. The controlled target also has a receiver for receiving an authorization key, and logic, which, responsive to the authorization key, selectively changes the change effecting device to a second state. When the change effecting device is in the second state, the target may operate according to a second utility. In one example, the controlled target has a restricted access key that was stored during manufacture, and the restricted access key is used by the logic in changing the state of the change effecting device. To change the utility of the controlled target, the controlled target is placed proximate to an activation device. The activation device may read an accessible identifier from the controlled target, and retrieve or generate an authorization key that is associated with the target. The activation device may cooperate with a network operation center or other entity to retrieve the authorization key, and to obtain approval to change the utility of the controlled target. If approved, the activation device may then send the authorization code to the controlled target.

A distribution control system is provided to support the controlled and selective changing of utility for a target. The target with controlled utility may be an electronic device, or alternatively, may be a tangible media, such as an optical disc. The distribution control system has a target with a change effecting device and a restricted access key. An activation device retrieves or generates an authorization key, and sends the authorization key to the target. The authorization key may be sent to the target wirelessly, for example, using a radio frequency signal. The target has logic that uses the restricted access key and the authorization key to change the utility of the target. In one example, the activation device retrieves the authorization key from a network operation center (NOC) by sending a target identifier to the NOC, and the NOC retrieves the authorization key for the identified target. The activation device may also connect to other systems for obtaining approval to change the utility of the target. For example, the authorization key may be sent to the target upon receiving payment, password, or other confirmation.

In a specific example of the distribution control system, a target is manufactured with a change effecting device set to compromise the utility of the target. In this way, the compromised target would be nearly useless to a thief, and therefore would be less likely to be a target of theft. The manufacturer has also stored an identifier and a restricted access key with the target. The manufacturer also stores the accessible identifier and its associated key for later retrieval by a party authorized to restore the utility to the target. In one example, the identifiers and keys are stored at a network operation center (NOC). The compromised target may be moved and transferred through the distribution chain with a substantially reduced threat of theft. When a consumer decides to purchase the target, the target is passed proximally to an activation device. Its accessible ID is read by activation device, and using a network connection to the NOC, sends the accessible ID. The NOC retrieves the authorization key for the target. Additional approvals may be obtained, for example, confirmation of payment, identification, password, or age. When approved, the activation device transmits the authorization key to the target, typically using a wireless communication. The target receives the authorization key, and using its logic, compares the authorization key to its stored restricted access key. If the keys match, then the target uses an activation power source to switch the state of the change effecting device. Then, the target will have full utility available to consumer.

The systems, processes, networks and devices for providing an RF activatable product are fully set out in the following U.S. patent application, which is incorporated herein by reference as if set forth in its entirety:
1. U.S. patent application Ser. No. 11/295,867, filed Dec. 7, 2005, and entitled “Device and Method for Selectively Activating a Target”.

Referring again to FIG. 1, a system for providing loan products is illustrated. System 10 operates on a conditional access network. Generally, the conditional access network system 12 allows products to be distributed through a distribution chain in a secured, authenticated, and controlled manner. More specifically, this means that the product may be disabled or deactivated at the time of manufacture, and then upon predefined conditions being met, may be activated as shown in block 21. Also, the conditional access network system allows for controlled and managed distribution of the product as shown in block 23. More specifically, the product may be monitored as it moves from entity to entity in the distribution chain, so that the location or holder of the product is known. With this information, the product's distribution path can be monitored, and the product can be restricted to only being handled by authorized distributors. The conditional access network system also allows for permanent deactivation of the product as shown in block 25. In this way, overstock merchandise, defective merchandise, recalled merchandise, or lost merchandise may be permanently deactivated upon presentation at a point-of-sale location. By providing for controlled activation of a product, controlled distribution of that product, and selective permanent deactivation of products, the conditional access network system enables more efficient and effective loan products to be offered.

In offering loans, a credit provider would first confirm that all entities handling the product are participating in the network system. For example, the manufacturer 31 must be able to deactivate the product at the point of manufacture, and those in the distribution chain 33 should be able to scan the product upon receipt and delivery so that the precise location of the product may be tracked. Further, retailers 35 need to have the proper point-of-sale activation equipment to activate the products. Provided the manufacture, entities in the distribution chain, and the retailer all participate in the program, the loan provider may be able to use the conditional access network system to offer improved loan products. Of course, the loan provider needs to confirm that all the products 37 are also selectively activatable and deactivatable in the network.

Once the loan provider has identified the entities in the distribution chain, including the manufacturer and retailer, and has confirmed the specific products that will be used as collateral for the loan, the loan provider is able to more effectively evaluate risk for providing the loan, and to assess the creditworthiness of the distribution process and collateral. This loan may be, for example, a line of credit against inventory, a loan against accounts receivable, or other loan instrument. Because the loan provider has increased visibility to the status of each individual product, and because the product may be more accurately monitored and controlled through its distribution chain, it is likely that more cost-effective and valuable loan terms may be provided as shown in block 16. For example, with timely, complete, and accurate receivable 38 information, and current information on collateral and inventory 39, the creditor is able to confirm that sufficient receivables or inventory are currently avaialable to cover the loan. Also, with the increased visibility to the collateral, the loan provider can make or adjust repayment and acceleration decisions, thereby protecting the loan and avoiding defaults. The conditional access network also provides current information that may be used by the creditor to assess risk of loss 40, which would include, for example, the risk of theft and the risk of not selling the product. Since the creditor has current information as to lost, stolen, and deactivated product information, the risk of loss may be factored into setting the loan terms.

The loan product may be automatically adapted responsive to current network information as shown in block 18. For example, the network system may be able to provide information to the creditor showing when specific products have been activated as shown in block 41. In a similar way, the network system may be able to inform the creditor when products have been permanently disabled as shown in block 43. In another example, the network system may be able to show the precise location of a specific product. Based upon this and other information, the creditor may automatically adapt the amount, terms, or rate for a loan. For example, if products are moved to a location not acceptable to the creditor, the creditor may immediately drop those products from collateral, and lower the loan amount, or increase the rate according to the increased risk. In another example, as products are activated or disabled, the collateral inventory may be reduced, so loan terms again can be adjusted. Of course, with some products being activated and moved to accounts receivable, a portion of the loan may use the increased accounts receivable to cover the loan. Since accounts receivable may have less risk of collection than an inventory product, the rate for that loan portion may be automatically reduced.

Advantageously, the loan system 10 enables a creditor to more fully assess risk for a particular product distribution process, and thereby offer more price competitive and valuable loan products to its clients. In a similar way, the debtors are able to better adjust business practices to control costs and terms of loans. For example, high risk distributors or high risk shipping companies may be avoided to reduce overall loan costs, or to support a larger loan amount. Also, by more precisely monitoring movement of collateral, the creditor is able to better protect its assets.

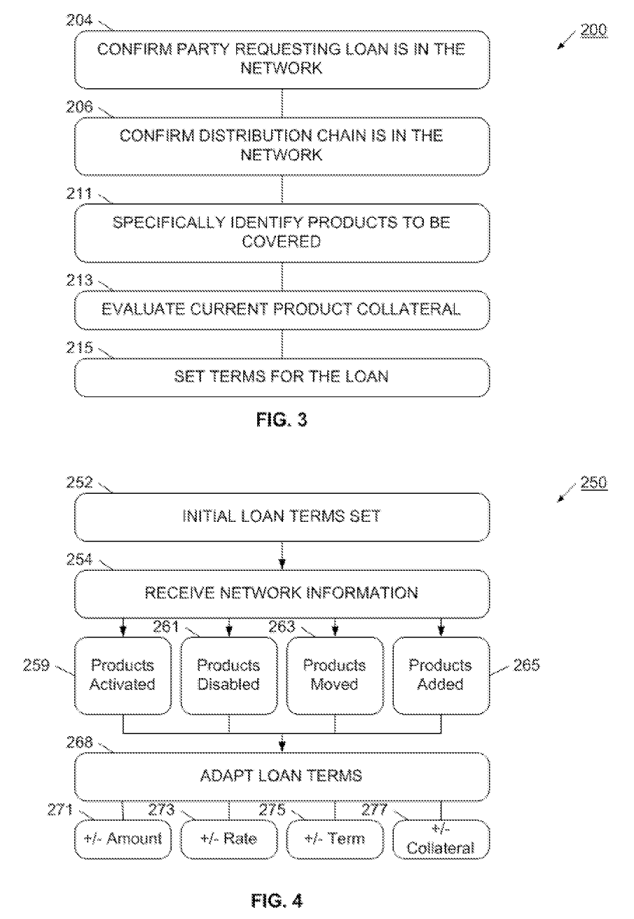

Referring now to FIG. 3, a general process for offering loan products is illustrated. Process 200 starts by having a creditor confirm that a party requesting a loan is on a conditional access network. The creditor also confirms that each entity in the distribution chain is in the network as shown in block 206. This would include manufacturers, shippers, warehouses, other distributors, and the retailer. Of course, if one or more of the distribution entities is not in the network, a loan may still be offered, but terms may be more restrictive or the rate increased. The creditor can also identify specifically the products to be covered as shown in block 211. More particularly, the creditor can identify the product down to the item level. This is possible, for example, because each product has a unique integrated circuit device embedded or attached to it, which has an identification number unique to that individual product. In this way, the creditor can identify collateral down to the item level, even for specific items such as DVDs, razors, drills, toys, or other relatively low-cost items. By enabling collateral down to the item level, the creditor is able to better manage the collateral, and may reduce defaults by having visibility to collateral reductions. Since the creditor has far more information than typical with known loan products, the creditor is able to more precisely evaluate risk and set accurate pricing for the loan product as shown in block 215. Typically, because of the increased information, the creditor is able to provide loan terms better adapted or tuned to the specific requirements of the requesting party. Further, since many of the factors used by the creditor to set loan terms are under the control of the requesting party, the requesting party may take the necessary actions to assist in obtaining desirable terms.

Referring now to FIG. 4, another loan product process 250 is illustrated. Process 250 starts with an initial loan having already been issued for a set of collateral products or receivables as shown in block 252. For example, this initial loan may have been set according to the process defined in FIG. 3. It will also be understood that the initial loan product may be set in other ways. The creditor receives information from the conditional access network as shown in block 254. This information may be received in a near real-time basis, or may be received periodically. This information received from the conditional access network may then be used to adapt the loan terms as shown in block 268. For example, the conditional network may inform the creditor as products are activated as shown in block 259. The network may also inform the creditor as products are permanently disabled as shown in block 261, or as products are moved between distributors as shown in block 263. The conditional access network may also be able to inform the creditor as products are added into the overall distribution chain. Using this and other information, the creditor may reassess risk or value of the collateral products, and make near real-time or periodic adjustments to the loan amount, rate, or term. In this way, by providing current information on location and status of products in the distribution chain, a near real-time adaptable loan product may be offered.

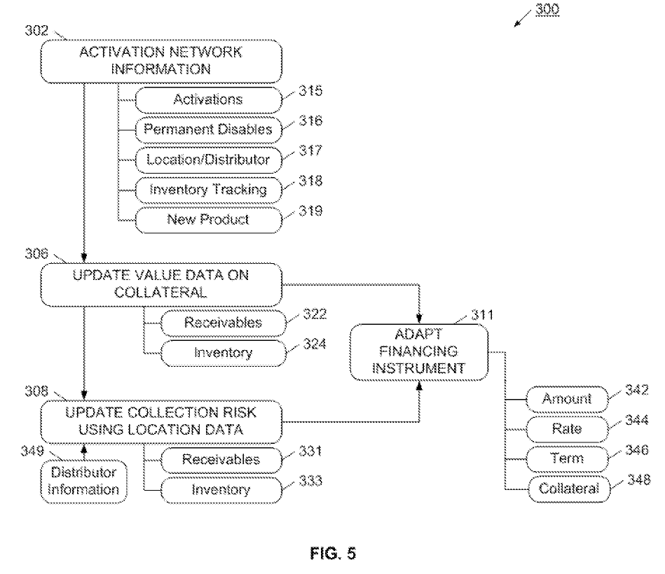

Referring now to FIG. 5, a process for providing a loan is illustrated. Process 300 advantageously uses information obtained from a conditional access network to facilitate improved loan products. Such an activation network as shown in block 302 may provide information as to particular products in the stream of commerce, which can define collateral for a loan. In the dynamic product distribution environment, products are continually entering and leaving the stream of commerce, and process 300 is able to accurately and timely assess status of collateral products. For example, the activation network is able to track when individual items are added into the network as shown in block 319. These new products may then be added as collateral against an existing loan, or may be used to determine terms for an initial loan. Importantly, the products are identifiable to the item level, so that even relatively inexpensive products may be accurately and completely monitored through the distribution channel. As products move through the distribution chain, the activation network is able to monitor and report particular locations for products, as well as which distributor or entity is in control of the product as shown in blocks 317 and 318. In this way, the creditor may be made aware of the status and location of collateral in a timely manner. As products are sold, the conditional access network activates them as shown in block 315. As products are activated, they are removed from the stream of commerce and are therefore not available as collateral. Accordingly, if a loan is secured against the collateral, the loan terms may be adjusted. Also, as previously discussed, the conditional access network is able to permanently disable a product from being activated. These disabling activities are reported as shown in block 316. Similar to activations, when products are disabled they are removed from the stream of commerce, and therefore are not available as collateral.

Information regarding products added to the inventory, activations, and disabling activities may be used to update value data on the collateral as shown in block 306. For example, the current level of inventory 324 may be timely updated according to new products, activations, and disabled products. In a similar manner, the accounts receivable 322 may be increased according to activations, and may be decreased when a previously sold product has been disabled. In this way, the creditor has timely information as to accounts receivable and inventory information. The creditor also receives timely information regarding where every collateral item is in the distribution chain. For example, a creditor is able to determine which distributors are in control of which products, and may use risk information 349 for those distributors in assessing risk of loss or likelihood of conversion for those products. This risk information may include historical performance, and may also include information obtained through the conditional access network. For example, some retailers may have receivables 331 which have a high rate of collection, while other retailers have a lower rate. The creditor can use this specific distributor information in defining terms for loan products. In a similar manner, some distributors may have a high degree of loss in their inventory 333, or may be particularly successful at converting inventory to revenue sales. Again, the creditor may use distributor information 349 for adjusting loan terms.

Based on the updated value of the collateral 306 and a good understanding of collection risk 308, the creditor is able to adapt the loan as shown in block 311. More particularly, the creditor may adapt the amount of the loan 342, the rate for the loan 344, the term or acceleration of the loan as shown in block 346, or may adjust collateral requirements as shown in block 348. It will be appreciated that other loan terms may be adjusted. In some cases, the process 300 may be fully automated using general purpose computer equipment.

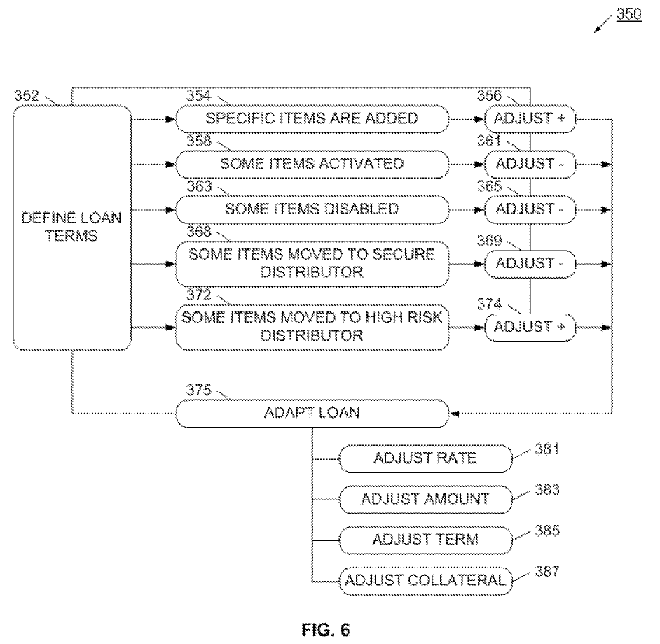

Referring now to FIG. 6, an automatically adaptable loan product 350 is illustrated. Product 350 has a set of defined loan conditions as shown in 352. For example, these defined loan conditions may be a set of rules that are associated with product value, location, and status. Accordingly, these rules may use information from the conditional access network to automatically set and adapt loan terms. In this way, a near real-time loan product is enabled. The product 350 may be used to provide automatically an initial loan, or to automatically adapt or adjust the loan as product status or location change. For example, the conditional access network may provide information as to when specific items are added to the stream of commerce as shown in block 354. This information is provided down to the item level, so that the loan may be written to particularly identify the item as collateral. As additional items are added to the stream of commerce, more advantageous loan terms (from the creditor perspective) may be offered due to the increased value of collateral, as shown in block 356.

The conditional access network may also provide timely information as to when some of the items are being activated as shown in block 358. As items are activated, they are removed from the stream of commerce and from the collateral, so the loan terms may be adjusted to reflect the reduced value of collateral in block 361. Of course, the value of accounts receivable may have increased due to the activations, so the increased receivables may more than offset the reduction in collateral. The conditional access network may also provide information as to when products are permanently disabled as shown in block 363. As these products are permanently disabled and removed from the stream of commerce, and from the collateral, so the loan terms may be adjusted to reflect the reduced value of collateral in block 365. The loan terms 352 may contain rules according to the specific location of products. For example, as items are moved to more secure distributors as shown in block 368, the loan terms may be improved as shown in block 369. However, as products are moved to more high risk distributors or locations as shown in block 372, the loan terms may become less desirable as shown in block 374. With these and other risk factors, the automated loan system may adaptively set loan terms as shown in 375. In this regard, the loan rate 381, loan amount 383, loan term 385, or collateral value 387 may all be set according to the predefined rules association with the loan terms 352.

Providing for Secure Activation

To provide the automated loan processes, a supporting activation network provides a system for authenticating and securing product transactions. An integrated circuit is attached to a target, such as an optical disc or electronic device. The integrated circuit has an RF transceiver that is capable of establishing communication with an associated reading device. The integrated circuit also has a hidden memory, which can not be read externally, and a user memory. The hidden memory stores an authentication message, while the user memory stores readable authentication information. The hidden authentication message and the authentication information are related through a cryptographic process. However, even though the integrated circuit benefits from the cryptographic security, the integrated circuit only operates relatively simple logic operations. In this way, a highly secure transaction is enabled without requiring significant processing power or time at the integrated circuit. When the integrated circuit is placed near the reader, the reader reads the authentication information, and with the cooperation of a network operation center, uses the authentication information to derive an activation code. The reader passes the activation code to the integrated circuit, which compares the activation code to its hidden activation message. If they have a proper relationship, the communication has been authenticated, and the integrated circuit proceeds to perform an action.

In one example, a random plaintext number is stored as the hidden authentication message, and the user memory has authentication information that includes an identifier, as well as an encrypted version of the plaintext number. When the integrated circuit is placed near a reader, the reader reads the authentication information, which is sent to a network operation center. The network operation center uses the identification information to retrieve a decryption key, and uses the key to decrypt the encrypted message to derive the plaintext number. The plaintext number is sent to the reader, which communicates it to the integrated circuit. The integrated circuit does a simple logical compare between the received number and the hidden number, and if they match, the integrated circuit proceeds to perform an action. The action may be, for example, activating or deactivating the product the circuit is attached to. The hidden authentication message and the authentication information are related through a cryptographic process. In this example, the integrated circuit benefits from the cryptographic security, even though the integrated circuit only operates a relatively simple logic operation. In this way, a highly secure transaction is enabled without requiring significant processing power or time at the integrated circuit.

In another example, an authentication code is stored as the hidden authentication message, and the user memory has authentication information that includes identifiers, as well as a public key that can be used to recreate the authentication code. When the integrated circuit is placed near a reader, the reader reads the authentication information, which is sent to a network operation center. The network operation center uses the identification information to retrieve a private key, and uses the public key, private key and other authentication information generate the authentication code. The authentication code is sent to the reader, which communicates it to the integrated circuit. The integrated circuit does a simple logical compare between the received code and the hidden code, and if they match, the integrated circuit proceeds to perform an action. The action may be, for example, activating or deactivating the product it is attached to. The hidden authentication message and the authentication information are related through a cryptographic process. In this example, the integrated circuit benefits from the cryptographic security, even though the integrated circuit only operates a relatively simple logic operation. In this way, a highly secure transaction is enabled without requiring significant processing power or time at the integrated circuit.

In yet another example, the present invention discloses a cryptographic process. Two pairs of public/private keys are generated in such a way that a combination of the first private key and the second public key is equivalent to the combination of the first public key with the second private key. The key combinations, when combined with additional meaningful information, produce a limited set of authentication messages. The process provides a highly secure method of authentication requiring minimal computation and power at the embedded processor.

Advantageously, the conditional access network enables a highly secure and authenticated transaction, even when the authorizing circuit is operating in a low-power, low processing capability environment. This means that an RFID tag or other RF-enabled integrated circuit may be used to communicate sensitive information, and become an integral part of a secure transaction process. This enables an RF-enabled circuit to perform secured actions, thereby allowing manufacturers to enforce distribution and use rules

The systems, processes, and devices for providing a secure activation network are fully set out in the following U.S. patent applications, all of which are incorporated herein by reference as if set forth in their entirety:
1. U.S. patent application Ser. No. 11/456,037, filed Jul. 6, 2006, and entitled “Device and System for Authenticating and Securing Transactions Using RF Communication”;
2. U.S. patent application Ser. No. 11/456,040, filed Jul. 6, 2006, and entitled “Method for Authenticating and Securing Transactions Using RF Communication”;
3. U.S. patent application Ser. No. 11/456,043, filed Jul. 6, 2006, and entitled “Device and Method for Authenticating and Securing Transactions Using RF Communication:’ and
4. U.S. patent application Ser. No. 11/456,046, filed Jul. 6, 2006, and entitled “System and Method for Loading an Embedded Device to Authenticate and Secure Transactions.
   Providing for Permanent Deactivation

To provide the automated loan processes, supporting deactivation devices and process are used. The deactivation systems have an integrated circuit device attached to a target. In one example, the integrated circuit device is a tag attached to or integrated with a product such as an electronic device or optical disc. In another example, the integrated circuit device may be integrated into the product's circuitry. The integrated circuit is controllable to effect an action at the target, such as activating or deactivating the usefulness of the product. The integrated circuit has a logic and memory section connected to an antenna for receiving communications from an associated reader or scanner. The integrated circuit also has a component constructed to transition from a first state to a permanent second state. For example, the component may be a fuse, a partial fuse, or an anti-fuse. The integrated circuit also stores a hidden secret kill code, and upon receiving a matching kill code from the reader, permanently transitions the component to its second state. When the component is in the permanent second state, the integrated circuit is incapable of effecting the action on the target. In this way, the integrated circuits ability to affect the target may be permanently disabled. The integrated circuit may also verify its function is disabled, and report a kill confirmation to the reader.

In one example, the integrated circuit is attached to an optical disc such as a DVD. The integrated circuit couples to an RF antenna for receiving data and power. The integrated circuit also has output ports connected to an electrochromic device, with the electrochromic device positioned over some important data on the disc. The optical disc is initially shipped with the electrochromic material in a darkened state, such that the DVD will not operate in an associated DVD player. If properly authorized, the integrated circuit is capable of transitioning the electrochromic material to a relatively transparent state, such that it activates the usefulness of the DVD so that it may be played. However, in some cases it may be desirable to cause the DVD to be permanently unplayable by disabling the ability of the integrated circuit to effect a change in the electrochromic material. Accordingly, the integrated circuit has a secret kill code in a write-once memory location. Upon receiving a matching kill code through the RF communication path, the integrated circuit causes a component to permanently transition to a second state. This component may be, for example, a fuse, a partial fuse, an anti-fuse, or a logic state. Upon transitioning the component, the integrated circuit is incapable of transitioning the electrochromic material to its transparent state. In this way, integrated circuit has been disabled from ever activating the DVD disc. The integrated circuit may also verify its ability to activate the disc is disabled, and report a kill confirmation to the reader. In this way, the retailer and manufacturer may be confident that the DVD has been permanently removed from the stream of commerce.

Advantageously, the kill process confidently and controllably allows products to be permanently disabled. In this way, manufacturers are enabled to more fully control the distribution of their products, and be assured that specific goods have been removed from the stream of commerce.

The systems, processes, and devices for permanently disabling the target from being activated are fully set out in the following U.S. patent application, which is incorporated herein by reference as if set forth in its entirety:
1. U.S. patent application Ser. No. 11/456,680, filed Jul. 11, 2006, and entitled “A Radio Frequency Activated Integrated Circuit and method of Disabling the Same”.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. An automated process for providing financing instruments, the automated process operating on a general purpose computer system, comprising:
receiving electronic messages from a conditional access network, the messages selected from the group consisting of: target activation message, target kill message, target movement message, and additional targets added message; and
adapting a financing instrument responsive to the received messages.

2. The automated process according to claim 1, wherein the step of adapting the financing instrument comprises calculating the value of remaining targets after removing value associated with activated and killed targets.

3. The automated process according to claim 1, wherein the step of adapting the financing instrument comprises adjusting a rate for the financing instrument.

4. The automated process according to claim 1, wherein the step of adapting the financing instrument comprises adjusting an obligation amount for the financing instrument.

5. The automated process according to claim 1, wherein the adapting step comprises adding the additional products as additional collateral.

6. The automated process according to claim 1, wherein the adapting step comprises changing a financing instrument term responsive to activation messages and kill messages.

7. The automated process according to claim 1, wherein the adapting step comprises changing a financing instrument term responsive to the product movement message.

8. The automated process according to claim 1, wherein the adapting step comprises using a set of financing instrument rules and the received messages to adapt the financing instrument.

9. The automated process according to claim 1, wherein the financing instrument is a loan.

10. The automated process according to claim 1, wherein the adapting step comprises accelerating repayment for at least a portion of the financial instrument.

11. The automated process according to claim 1, wherein the adapting step comprises suspending a line of credit under the financing instrument.

12. The automated process according to claim 1, further including the step of communicating a legal notice, repayment notice, or default notice responsive to the received messages.

13. A process for providing a financing instrument using targets as collateral, comprising:
confirming the manufacturer of the products uses a conditional access network to disable the targets;
confirming distribution entities for the targets use a conditional access network to track the targets;
confirming selling entities for the targets use a conditional access network to activate the targets;
receiving location and activation information for the targets from the conditional access network; and
adapting the financing instrument according to the received information.

14. The process according to claim 13, wherein the receiving step comprises receiving automated messages from the conditional access network.

15. The process according to claim 13, wherein the adapting step comprises using computerized algorithms to adapt the financing instrument according to the received automated messages.

16. The process according to claim 13, wherein the adapting step comprises using computerized algorithms to adapt the financing instrument.

17. A process for automatically tracking targets as collateral for a loan, comprising:
receiving new target information from a conditional access network, the new target information specifically identifying targets to be added as collateral;
receiving distributor information from the conditional access network, the distributor information usable to determine the distributors in control of the targets;
receiving activation information from the conditional access network, the activation information usable to remove the activated targets from the collateral;
determining the value of the collateral responsive to the received information.

18. The process for automatically tracking targets according to claim 17, further including the step of receiving kill information from the conditional access network, and using the kill information to remove the killed targets from the collateral.

19. The process for automatically tracking targets according to claim 17, further including the step of adjusting an accounts receivable responsive to the activation information.

20. An automated financing instrument, comprising:
a scope of collateral defined by:
increasing according to received messages indicating additional deactivated targets are added to inventory;
reducing according to received messages indicating a collateral target has been activated; and
reducing according to received messages indicating a collateral target has been permanently disabled; and
a risk defined by:
messages received indicating status of the targets; and
messages received indicating location of the targets.

21. The automated financing instrument according to claim 20, further including the step of setting terms for the financing instrument according to the scope of collateral and the risk.

22. The automated financing instrument according to claim 20, further including the step of setting an amount or rate for the financing instrument according to the scope of collateral and the risk.

23. The automated financing instrument according to claim 20, further including the step of setting initial terms for the financing instrument according to the scope of collateral and the risk.

24. The automated financing instrument according to claim 20, further including the step of setting an initial amount or rate for the financing instrument according to the scope of collateral and the risk.

25. The automated financing instrument according to claim 20, further including the step of adapting terms for a pre-existing financing instrument according to the scope of collateral and the risk.

26. The automated financing instrument according to claim 20, further including the step of adapting amount or rate for a pre-existing financing instrument according to the scope of collateral and the risk.

27. The automated financing instrument according to claim 20, wherein the messages are received from a conditional access network.

28. The automated financing instrument according to claim 20, wherein the messages received indicating status are kill-confirmation messages or activation messages.

29. The automated financing instrument according to claim 20, wherein the messages received indicating location are messages confirming which distribution party has control of the respective target.
